(19) United States
(12) Patent Application Publication
(10) Pub. No.: US 2008/0277637 A1
(43) Pub. Date: Nov. 13, 2008

(54) Lifting Mechanism

(76) Inventor: Peter Heinrichs, Wegberg (DE)

Correspondence Address: Friedrich Kueffner, 317 Madison Avenue, Suite 910, New York, NY, 10017, US

(21) Appl. No.: 10/575,328

(22) PCT Filed: Oct. 12, 2004
(86) PCT No.: PCT/EP2004/052812

§ 371 Date: Jul. 18, 2008

(30) Foreign Application Priority Data
Oct. 15, 2003 (DE) 10348666.6

(51) Int. Cl. B66D 1/14

(52) U.S. Cl. 254/342

(57) ABSTRACT

The invention relates to a lifting mechanism comprising a rotatably mounted drum (5) for winding a traction element (4). Said element can be rotated by means of a rotary drive unit (19) comprising at least one rotary drive motor (21, 22) that acts on the drum (5) by means of a multi-speed summation gear (20).

The invention relates to a drawworks of the type corresponding to the preamble of claim 1.

Such drawworks serve to lower and withdraw a load, in particular a drilling device, for example from a platform into a borehole or onto the sea bottom. They have a flexible traction element, the one end of which is fastened to the drilling device. The other end of the traction element is fastened to a rotatably mounted winding drum, with which the traction element can be wound up and unwound.

At least one rotary drive device is provided for the rotary drive of the drum. This rotary drive device regularly comprises a direct-current motor. In order to be able to drive the drum over a relatively wide speed range with virtually constant, high output, a gearbox is connected on the output side of the direct-current electric motor, the input shaft of this gearbox being coupled to the direct-current electric motor and its output shaft being coupled to the drum.

In a first embodiment of such known drawworks, the applied torque is transmitted to the drum by means of a link chain. Although these “chain-driven drawworks” have relatively compact external dimensions, a disadvantage is that the chain sag which is always present in the lower lay of the chain drive, during “four-quadrant operation” in which both acceleration and braking can be effected during both the lifting and the lowering of the load, change to the upper lay, and jerky operation with considerable peak forces acting on the traction element could occur as a result. This entails a considerable risk, since the tensile strength of the traction element may be exceeded by these peak forces, a factor which would lead to tearing of the traction element, with the disastrous consequences associated therewith.

Wirth Maschinen-und Bohrgeräte-Fabrik GmbH, Erkelenz, has therefore disclosed a drawworks which comprises two drive units, consisting of a direct-current electric motor with gearbox connected on the output side, in which the gear output shafts each carry a gearwheel pinion which meshes with a gearwheel mounted on the drum shaft in a rotationally fixed manner. The two rotary drive devices are arranged next to one another in extension of the drum axis on one of the end faces in such a way that the meshing of the gearwheel pinion with the gearwheel located on the drum shaft takes place offset by 180° relative to the drum axis. Beyond the other end face of the drum, a disk brake and an eddy-current brake are provided one behind the other as viewed in the direction of the drum axis and are connected to the drum shaft in a rotationally fixed manner.

With this gear-driven drawworks—in contrast to the chain-driven drawworks—“four-quadrant operation” is possible without this leading to the undesirable peak forces in the traction element. Due to the possibility of immediately using the drive motors for braking the drum rotation, a considerable energy saving can be achieved by virtue of the fact that it is possible to directly feed in the electrical energy obtained by the braking action. Furthermore, the mechanical disk brake device is used much less frequently than in the chain-driven drawworks, as a result of which, firstly, its wear and wear-induced downtimes of the drawworks and, secondly, the offending noise regularly occurring in the case of mechanical brake devices are reduced to a minimum.

Although this gear-driven drawworks has often proved successful in recent years, a disadvantage is its considerable space requirement, which in particular makes it unsuitable for replacing more compact chain-driven drawworks.

It is known that alternating-current rotary drive electric motors have a high torque over a far larger speed range than direct-current motors. It has therefore become known to equip gear-driven drawworks of the type described above with the alternating-current electric motors without gearboxes as replacement for direct-current electric motor/gearbox units, since the overall length of the drawworks is reduced as a result. However, a considerable disadvantage consists in the fact that, in particular when the gear-driven drawworks is to be used as replacement for a chain-driven drawworks operated by direct current, the entire electrical operating apparatus has to be converted from direct current to alternating current, which regularly involves an unacceptable cost.

WO 01/64573 A2 discloses a drawworks in which two rotary drive devices are arranged next to the drum, in relation to the rotation axis of the drum, in such a way that the drum and the rotary drive devices, in a projection perpendicular to the rotation axis of the drum, at least partly overlap. This considerably reduces the overall length of the drawworks. The length of the drawworks is therefore determined essentially by the drum and the units connected on the input side or output side in the direction of the drum axis. The drive shafts of the rotary drive motors and the input and output shafts of the summation gear are arranged so as to lie on a common straight line.

The gear unit is a gear train which is coupled to the drum shaft via a summation gear.

Although this drawworks is characterized by a special performance, it is a disadvantage that it involves considerable production outlay.

The object of the invention is therefore to develop a drawworks of the generic type in such a way that its production outlay is reduced without its performance and operational reliability being impaired as a result.

Owing to the fact that the summation gear, i.e. the gear which transmits to the drum the torque delivered by at least one, preferably at least two rotary drive motors, is designed as a multi-speed gear, the gearbox hitherto connected on the output side of each rotary drive motor can be dispensed with. The outlay associated with the production of the drawworks is therefore considerably reduced. Furthermore, the fact that the summation gear designed as a multi-speed gear has a lower weight than a plurality of separate gearboxes has an advantageous effect, so that firstly the entire drawworks becomes lighter and secondly its frame, which carries all the components, need not be so robust. The latter once again reduces the production outlay and the weight. In addition, only a single shift element is required for the shift action, and not, as hitherto, a separate shift element for each gearbox, so that, if the shift element is actuated hydraulically, the hydraulic system and—if present—an electronic control system are also simplified.

In a first preferred embodiment of the drawworks according to the invention, the rotary drive device, relative to the rotation axis of the drum, is arranged next to the drum in such a way that the drum and the rotary drive device, in a projection perpendicular to the rotation axis of the drum, at least partly overlap. A drawworks having such a geometrical arrangement of the components is characterized by an especially short type of construction.

In this embodiment of the drawworks, the drive shafts of the rotary drive motors are arranged so as to lie on a common straight line.

In a further embodiment of the drawworks according to the invention, the at least two rotary drive motors are arranged next to one another in extension of the rotation axis of the drum. Although the drawworks is of longer construction than in the case of the above embodiment due to this geometrical design, its width is substantially reduced.

Both embodiments of the drawworks according to the invention can be used alternatively depending on the space conditions.

The drum is preferably connected in a rotationally fixed manner to a rotatably mounted drum shaft.

The drum shaft is then preferably connected to the output side of a gear unit, the input side of which is coupled to the output shaft of the gearbox.

If the drum shaft is coupled at one end to a mechanically acting brake device and at the other end to an electromagnetically acting brake device, a high braking torque can be exerted on the drum if required by simultaneous actuation of the two brake devices without torsion forces occurring on one side of the drum shaft, as would be the case if only one end of the drum shaft were coupled to brake devices.

The mechanically acting brake device is preferably a disk brake and the electromagnetically acting brake device is preferably an eddy-current brake.

The rotary drive motors may be optionally designed as direct-current electric motors or as alternating-current electric motors. Although the latter require technically more complicated activation, their useful speed range is greater, so that the number of shift actions can be reduced during operation of the drawworks. It is also possible to use hydraulic motors.

In order to avoid overloading of the drive motors of the rotary drive devices, the summation gear is preferably equipped with a safety device which, if a maximum admissible torque to the input shaft is exceeded, switches over the gearbox automatically into the gear of the largest ratio of the speed of the input shaft to the speed of the output shaft.

An exemplary embodiment of the invention is shown in the drawing, in which:

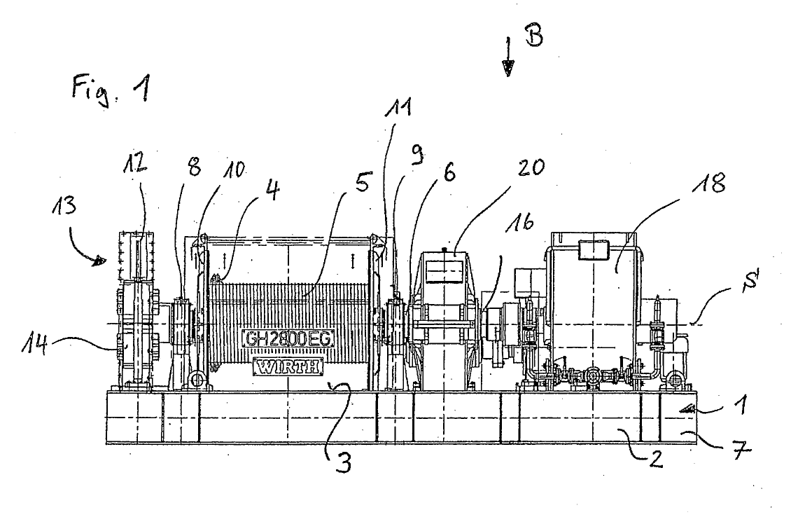

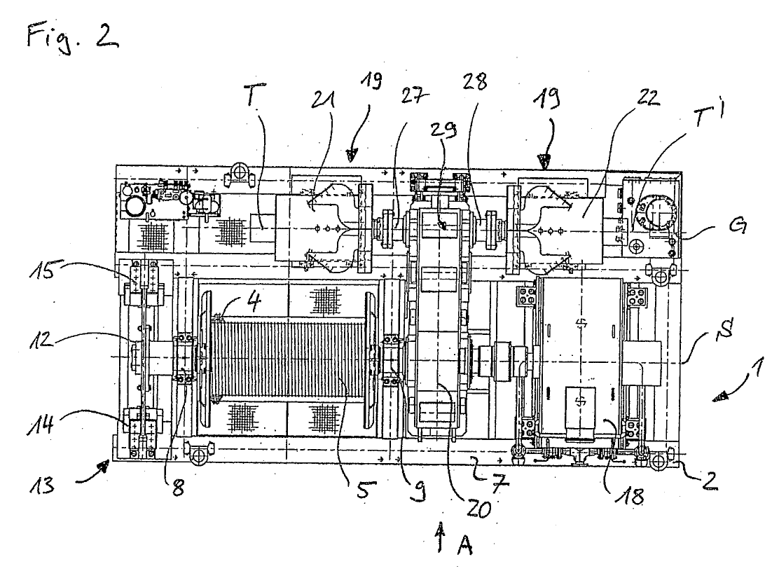

FIG. 1 shows an embodiment of a drawworks according to the invention in a side view (view A in FIG. 2);

FIG. 2 shows the same drawworks as in FIG. 1 in a view from above (view B in FIG. 1);

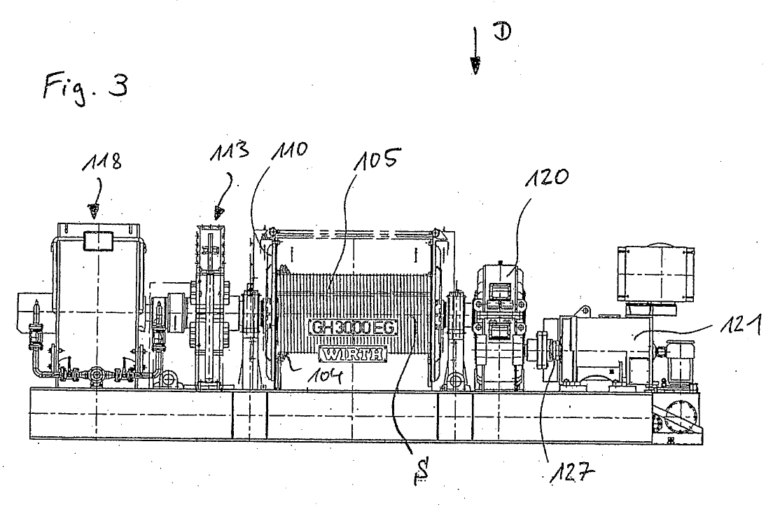

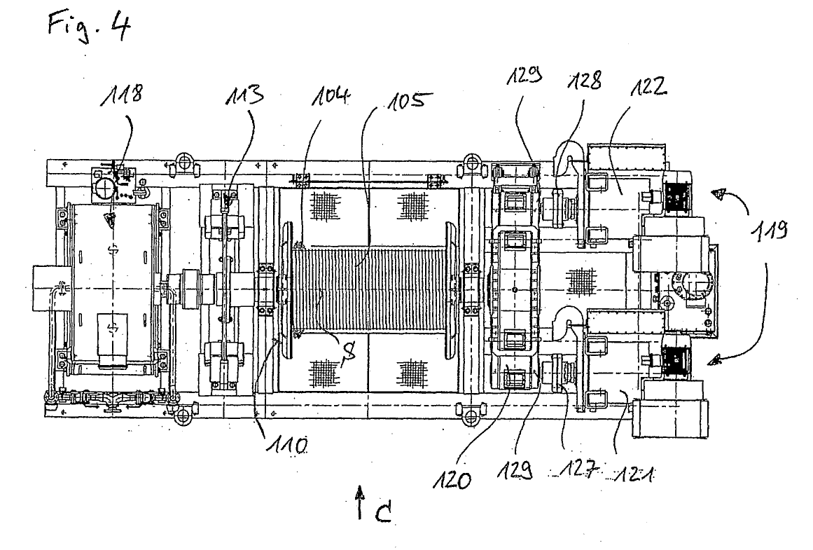

FIG. 3 shows a second embodiment of a drawworks according to the invention in a side view corresponding to FIG. 1 (view C in FIG. 4); and

FIG. 4 shows the same drawworks as in FIG. 3 in a view from above corresponding to FIG. 2 (view D in FIG. 3).

The drawworks designated overall by 100 in FIGS. 1 and 2 comprises a frame 1 which is rectangular in horizontal projection and consists of steel I-girders 2 welded to one another. The components, described below, of the drawworks are fastened to the top horizontal surfaces 3 of the girders 2 by screwing.

For withdrawing and lowering a drilling implement, the drawworks 100 comprises a flexible traction element 4 which is designed as a steel rope and can be wound up and unwound by means of a drum 5.

The drum 5 is fastened in a rotationally fixed manner to a drum shaft 6, the axis S of which runs parallel to the longitudinal sides 7 of the frame 1. It is mounted in bearing blocks 8, 9 which are arranged beyond the two end faces 10, 11 of the drum 5. That end of the drum shaft 6 which is shown on the left in the drawing is fastened in a rotationally fixed manner to the disk 12 of a disk brake arrangement 13, which comprises two brake calipers 14, 15 offset by 180° in the direction of rotation of the axis S. By means of the disk brake arrangement 13, the drum 5 can be braked in its rotary speed or even completely stopped during the unwinding operation of the flexible traction element 4. Beyond the other end face 11, the drum shaft 16 is connected to the output side 16 of a summation gear 20, still to be described in detail, and to an eddy-current brake 18 following in the direction of the axis S. The eddy-current brake 18 likewise serves to brake the unwinding speed of the drum 5. It is used in preference to the disk brake arrangement, since the braking energy is applied free of wear and without an offending noise caused by mechanical engagement.

In addition to the arrangement consisting of disk brake arrangement 13, drum 5, eddy-current brake 18 and the output side 16, lying between the drum 5 and the eddy-current brake 18, of the summation gear 20, a rotary drive device 19 is fastened to the frame 1. It comprises two direct-current electric motors 21, 22, the output shafts of which are connected in a rotationally fixed manner to the respective input shaft of the summation gear 20.

The summation gear 20 is one which is designed as a multi-speed gear. At least two transmission ratios can thus be selected, as a result of which the load range and the speed range for which the drawworks is suitable are increased. This is of special importance in particular when using direct-current electric motors on account of their limited useful speed range.

The rotary drive motors 21, 22 are arranged spatially in such a way that their output shafts 27, 28 face one another and the rotation axes T, T′ of the output shafts 27, 28 lie on a common straight line. Both output shafts 27, 28 are connected to the input side 29 of the summation gear 20 and act on a gearwheel (not shown in the drawing) which is connected to the drum shaft 6 via a shift device of known type of construction with optionally at least two different transmission ratios and a gearwheel (likewise not shown) provided on the output side 16 of the summation gear 20. The summation gear 20 therefore serves to transmit torque between the output shafts 27, 28 of the rotary drive motors 21, 22 and the drum shaft 6. When the flexible traction element 4 is being wound up onto the drum 5, the rotary drive device 19 drives the drum shaft 6 via the summation gear 20; the braking of the drum 5, which is necessary when the flexible traction element 4 is being unwound from the drum 5, may likewise be effected by the rotary drive motors 21, 22, which then act as generators. Since the kinetic energy of the rotating drum is thereby converted into electrical energy, energy can be saved in this way by feedback, if desired.

A considerable advantage of the coupling of the output shafts 27, 28 of the rotary drive motors to the drum shaft 6 via the multi-speed summation gear 20 is that interposed gearboxes can be dispensed with. In addition to a reduction in the production costs, the space required by the drawworks is also reduced, since other necessary components—for example hydraulic units—can be accommodated instead of the gearbox.

The summation gear 20 is equipped with a safety clutch (not shown in the drawing) which, if the respectively driven rotary drive motor 21, 22 is overloaded, automatically selects the lowest transmission of the summation gear 20 in order to minimize the torque to be applied by the rotary drive motors 21, 22 in this operating state. The safety clutch is conceived in such a way that, in this “first” gear, loading induced by spring force prevents release of the clutch independently of hydraulic pressure present, via which the clutch is actuated, and thus torque transmission is ensured. Furthermore, a feeding device (not shown in the drawing) is preferably integrated in the drawworks according to the invention, this feeding device being suitable for lowering and lifting the drilling implement even during the drilling operation and setting the pressure force of the drilling implement on the borehole bottom to a desired value. To this end, the feeding device may be operated in the following three different ways:
a) “constant load” i.e. the feeding device detects the force with which the drilling implement bears on the borehole bottom and regulates this force to a predetermined value;
b) “constant speed” i.e. the drilling implement is fed at constant speed, and
c) “constant mud pressure” i.e. the feeding speed is regulated in such a way that the pressure of the drilling fluid for a drive motor, driven by the drilling fluid, of the drilling implement is constant during the cutting action.

Furthermore, the drawworks according to the invention is equipped with a double filter system (not shown in the drawing), with which the hydraulic oil required for the operation of the hydraulically driven components of the drawworks, for example the disk brake arrangement 13 and the summation gear 20, is effectively filtered. The two filters of this double filter system are fitted into branches which can be optionally switched on independently of one another in the hydraulic circuit. This ensures that, as soon as the filter capacity is exhausted at one of the two filters, a changeover to the other filter can be effected without interrupting the operation.

A second preferred embodiment of the drawworks according to the invention is shown in FIGS. 3 and 4 and is designated overall by 200. In order to avoid repetitions, only the constructional differences from the embodiment according to FIGS. 1 and 2 are to be dealt with below. Components which correspond with regard to their effect are designated by reference numerals increased by 100 relative to the embodiment according to FIGS. 1 and 2.

In this drawworks, the rotary drive motors 121, 122 are arranged next to one another in extension of the rotation axis S and the drum 105. Accordingly, the summation gear 120 has two input sides 129 which are each connected to an output shaft 128 of a rotary drive motor 121, 122.

Furthermore, the disk brake arrangement 113 and the eddy-current brake 118 according to FIGS. 3 and 4 are arranged on the left next to the end face 110 of the drum 105.

On account of this arrangement of the components of the drawworks according to the invention, the embodiment according to FIGS. 3 and 4 is of narrower construction, but is longer, than that according to FIGS. 1 and 2, as is immediately obvious by comparing the figures.

### LIST OF DESIGNATIONS

1 Frame
2 Girder
3 Horizontal surface
4 Flexible traction element
5 Drum
6 Drum shaft
7 Longitudinal side
8 Bearing block
9 Bearing block
10 End face
11 End face
12 Disk
13 Disk brake arrangement
14 Brake caliper
15 Brake caliper
16 Output side
18 Eddy-current brake
19 Rotary drive device
20 Summation gear
21 Rotary drive motor
22 Rotary drive motor
27 Output shaft
28 Output shaft
29 Input side
100 Drawworks
S Axis
T, T′ Rotation axes
G Straight line
104 Flexible traction element
105 Drum
110 End face
113 Disk brake arrangement
118 Eddy-current brake
121 Rotary drive motor
122 Rotary drive motor
127 Output shaft
128 Output shaft
129 Input shaft
200 Drawworks

1. A drawworks for lowering and withdrawing a load, in particular a drilling device, having a flexible traction element (4, 104) which is fastened to the load, having a drum (5, 105), mounted so as to be rotatable about a rotation axis (S), for winding up the traction element (4), and having at least one rotary drive device (19, 119) which comprises at least one rotary drive motor (21, 22, 121, 122) which acts on the drum (5, 105) via a summation gear (20, 120) and with which the drum (5, 105) can be rotationally driven optionally in the lowering or withdrawing direction of the traction element (4, 104), wherein the summation gear (20, 120) is designed as a multi-speed gear.

2. The drawworks as claimed in claim 1, wherein the rotary drive device (19, 119) comprises at least two rotary drive motors (21, 22; 121, 122).

3. The drawworks as claimed in claim 2, wherein the rotary drive device (19), relative to the rotation axis (S) of the drum (5), is arranged next to the drum (5) in such a way that the drum (5) and the rotary drive device (19), in a projection perpendicular to the rotation axis (S) of the drum (5), at least partly overlap.

4. The drawworks as claimed in claim 3, wherein the drive shafts of the rotary drive motors (21, 22) are arranged so as to lie on a common straight line.

5. The drawworks as claimed in claim 2, wherein the at least two rotary drive motors (121, 122) are arranged next to one another in extension of the rotation axis (S) of the drum (105).

6. The drawworks as claimed in claim 1, wherein the drum (5, 105) is connected in a rotationally fixed manner to a rotatably mounted drum shaft (6).

7. The drawworks as claimed in claim 6, wherein the drum shaft (5, 105) is connected to the output side (16, 116) of the summation gear (20, 120), the input side (29, 129) of which is coupled to the output shafts (27, 28; 127, 128) of the rotary drive motors (21, 22; 121, 122).

8. The drawworks as claimed in claim 1, wherein the summation gear (20, 120) is a mechanically acting two-speed gearbox.

9. The drawworks as claimed in claim 6, wherein the drum shaft (6) is coupled at one end to a mechanically acting brake device and at the other end to an electromagnetically acting brake device.

10. The drawworks as claimed in claim 9, wherein the mechanically acting brake device is a disk brake arrangement (13) or a disk or multiple-disk brake, and the electrically acting brake device is an eddy-current brake.

11. The drawworks as claimed in claim 1, wherein the at least one rotary drive motor (21, 22; 121, 122) is a direct-current electric motor.

12. The drawworks as claimed in claim 1, wherein the at least one rotary drive motor (21, 22; 121, 122) is an alternating-current electric motor.

13. The drawworks as claimed in claim 1, wherein the at least one rotary drive motor (21, 22; 121, 122) is a hydraulic motor.

14. The drawworks as claimed in claim 1, wherein the summation gear (20, 120) is equipped with a safety device which, if a maximum admissible torque at the input shaft is exceeded, switches over the gearbox automatically into the gear of the highest ratio of the speed of the input shaft to the speed of the output shaft.
